(19) United States
(12) Patent Application Publication
(10) Pub. No.: US 2026/0302327 A1
(43) Pub. Date: Oct. 1, 2026

(54) LITHIUM ION SECONDARY BATTERY

(71) Applicant: HONDA MOTOR CO., LTD., Tokyo (JP)

(72) Inventors: Noritaka KIMURA, Saitama (JP); Tomohiro KINOSHITA, Saitama (JP); Takeshi FUJINO, Saitama (JP)

(21) Appl. No.: 19/567,287

(22) Filed: Mar. 16, 2026

(30) Foreign Application Priority Data
Mar. 28, 2025 (JP) 2025-056428

(51) Int. Cl. H01M 10/0525; H01M 10/0562

(52) U.S. Cl. CPC H01M 10/0525; H01M 10/0562; H01M 2300/0068

(57) ABSTRACT

Provided is a lithium ion secondary battery including: a positive electrode; a negative electrode containing a lithium metal or a lithium alloy; an electrolytic solution; and a separator, in which the electrolytic solution has a viscosity at 20° C. of less than 7.0 mPa·s, the separator includes a substrate and a functional layer formed on at least one surface of the substrate, and the separator saturated and impregnated with the electrolytic solution has an ionic resistance per unit area of 0.30 Ω·cm² or less.

This application is based on and claims the benefit of priority from Japanese Patent Application No. 2025-056428, filed on 28 Mar. 2025, the content of which is incorporated herein by reference.

### BACKGROUND OF THE INVENTION

### Field of the Invention

The present invention relates to a lithium ion secondary battery.

### Related Art

In recent years, research and development has been conducted on lithium ion secondary batteries that contribute to energy efficiency in order to ensure many people have access to reliable, sustainable, and advanced energy at reasonable prices.

PCT International Publication No. WO2023/090439 discloses a nonaqueous electrolyte energy storage device including: a negative electrode including a negative electrode active material layer containing a lithium metal; a positive electrode including a positive electrode active material layer; a nonaqueous electrolyte containing a nonaqueous solvent including a fluorine solvent; and a separator including a substrate layer and an inorganic particle layer laminated on a surface of the substrate layer. In the nonaqueous electrolyte energy storage device, the surface of the negative electrode active material layer and the surface of the inorganic particle layer are stacked so as to face each other. In addition, the separator has an air permeability of equal to or more than 110 sec/100 cm³ and equal to or less than 450 sec/100 cm³.
Patent Document 1: PCT International Publication No. WO2023/090439

### SUMMARY OF THE INVENTION

However, in the nonaqueous electrolyte energy storage device disclosed in PCT International Publication No. WO2023/090439, when charging and discharging is repeated at a high current density, the growth of dendrites is promoted, and the dendrites penetrate the separator and come into contact with the positive electrode, resulting in reducing the voltage even in an open circuit, whereby a micro short-circuit may occur. This is because dendrites are more likely to occur when a charging reaction in which lithium ions pass through the separator to form a lithium metal at the negative electrode and a discharging reaction in which a lithium metal dissolves and becomes lithium ions proceed unevenly, whereas the higher the current density, the more likely the charging and discharging reactions to proceed unevenly.

An object of the present invention is to provide a lithium ion secondary battery capable of preventing a micro short-circuit even when charging and discharging is repeated at a high current density.

(1) A lithium ion secondary battery including: a positive electrode; a negative electrode containing a lithium metal or a lithium alloy; an electrolytic solution; and a separator, in which the electrolytic solution has a viscosity at 20° C. of less than 7.0 mPa·s, the separator includes a substrate and a functional layer formed on at least one surface of the substrate, and the separator saturated and impregnated with the electrolytic solution has an ionic resistance per unit area of 0.30 Ω·cm² or less.

(2) In the lithium ion secondary battery as described in (1) above, the separator saturated and impregnated with the electrolytic solution has an ionic resistance per unit area of 0.14 Ω·cm² or more and 0.25 Ω·cm² or less.

(3) In the lithium ion secondary battery as described in (1) or (2) above, the functional layer contains inorganic oxide particles.

(4) In the lithium ion secondary battery as described in any one of (1) to (3) above, in the separator, a ratio of a thickness of the functional layer to a thickness of the substrate is 0.30 or less.

(5) In the lithium ion secondary battery as described in (4), in the separator, the ratio of the thickness of the functional layer to the thickness of the substrate is 0.25 or less.

(6) In the lithium ion secondary battery as described in any one of (1) to (5), a rate of change in thickness of the separator after application of a pressure of 3 MPa for 100 hours is 11.0% or less.

(7) In the lithium ion secondary battery as described in any one of (1) to (6), the lithium ion secondary battery has an initial restraint load of 0.5 MPa or more.

According to the present invention, it is possible to provide a lithium ion secondary battery capable of preventing a micro short-circuit even when charging and discharging is repeated at a high current density.

### DETAILED DESCRIPTION OF THE INVENTION

An embodiment of the present invention will be described below.

A lithium ion secondary battery of the present embodiment includes a positive electrode, a negative electrode containing a lithium metal or a lithium alloy, an electrolytic solution, and a separator. Here, the separator includes a substrate and a functional layer formed on at least one surface of the substrate.

Viscosity of the electrolytic solution at 20° C. is less than 7.0 mPa·s, and preferably less than 6.5 mPa·s. Since the viscosity of the electrolytic solution at 20° C. is less than 7.0 mPa·s, the lithium metal dissolves and precipitates uniformly in the negative electrode during charging and discharging, and as a result, micro short-circuits are prevented even when charging and discharging are repeated at a high current density. The viscosity of the electrolytic solution at 20° C. is, for example, 2.0 mPa's or more.

An ionic resistance per unit area of the separator saturated and impregnated with the electrolytic solution is 0.30 Ω·cm² or less, and preferably 0.25 Ω·cm² or less. Since the ionic resistance per unit area of the separator saturated and impregnated with the electrolytic solution is 0.30 Ω·cm² or less, the lithium metal dissolves and precipitates uniformly in the negative electrode during charging and discharging, and as a result, micro short-circuits are prevented even when charging and discharging are repeated at a high current density. This is presumably because uneven distribution of the electrolytic solution in pores of the separator is prevented, and as a result, a concentration of lithium ion is uniform on a surface of the negative electrode. In addition, when the ionic resistance per unit area of the separator saturated and impregnated with the electrolytic solution is 0.25 Ω·cm² or less, an increase in thickness of the lithium metal or the lithium alloy is prevented even when charging and discharging are repeated at a high current density. The ionic resistance per unit area of the separator saturated and impregnated with the electrolytic solution is, for example, 0.10 Ω·cm² or more.

The functional layer preferably contains inorganic oxide particles. Thus, micro short-circuits are prevented even when charging and discharging are repeated at a high current density. Examples of the inorganic oxides are not particularly limited, and include iron oxide, silicon oxide, aluminum oxide, titanium oxide, zirconium oxide, calcium oxide, strontium oxide, barium oxide, and magnesium oxide. Among these, aluminum oxide is preferred.

The functional layer may contain inorganic nitride particles instead of the inorganic oxide particles or in addition to the inorganic oxide particles. Examples of the inorganic nitrides are not particularly limited, and include aluminum nitride and silicon nitride.

Furthermore, the functional layer may further contain a binder, a conductive additive, and the like. Examples of the binder are not particularly limited, and include polyvinylidene fluoride, polyacrylic acid, carboxymethyl cellulose, and styrene butadiene rubber. Examples of the conductive additive are not particularly limited, and include carbon nanotubes.

A ratio of the thickness of the functional layer to the thickness of the substrate is preferably 0.30 or less, and more preferably 0.25 or less. When the ratio of the thickness of the functional layer to the thickness of the substrate is 0.30 or less, micro short-circuits are prevented even when charging and discharging are repeated at a high current density. In addition, when the ratio of the thickness of the functional layer to the thickness of the substrate is 0.25 or less, an increase in thickness of the lithium metal or the lithium alloy is prevented even when charging and discharging are repeated at a high current density. The ratio of the thickness of the functional layer to the thickness of the substrate is, for example, 0.10 or more. The thickness of the functional layer is not particularly limited, and is, for example, 2 μm or more and 4 μm or less.

A rate of change in thickness of the separator after application of a pressure of 3 MPa for 100 hours is preferably 11.0% or less, and more preferably 9.0% or less. When the rate of change in thickness of the separator after application of a pressure of 3 MPa for 100 hours is 11.0% or less, micro short-circuits are prevented even when a high initial load is applied and charging and discharging are repeated at a high current density.

Examples of the substrate are not particularly limited as long as being impregnated with the electrolytic solution, and include woven fabric, nonwoven fabric, and porous resin film. Examples of materials constituting the substrate are not particularly limited, and include polyolefins such as polyethylene and polypropylene.

An initial restraint load of the lithium ion secondary battery of the present embodiment is preferably 0.5 MPa or more, and more preferably 0.7 MPa or more. When the initial restraint load of the lithium ion secondary battery of the present embodiment is 0.5 MPa or more, micro short-circuits are prevented even when charging and discharging are repeated at a high current density. In addition, when the initial restraint load of the lithium ion secondary battery of the present embodiment is 0.7 MPa or more, an increase in thickness of the lithium metal or the lithium alloy is prevented even when charging and discharging are repeated at a high current density. The initial restraint load of the lithium ion secondary battery of the present embodiment is, for example, 1.5 MPa or less.

The electrolytic solution contains, for example, a supporting electrolyte and an organic solvent.

Examples of the supporting electrolyte are not particularly limited as long as being a lithium salt, and include lithium bis(fluorosulfonyl)imide, lithium (fluorosulfonyl)(trifluoromethylsulfonyl)imide, lithium (fluorosulfonyl)(pentafluoroethylsulfonyl)imide, lithium hexafluorophosphate, and lithium tetrafluoroborate, and two or more of these may be used in combination. Among these, lithium bis(fluorosulfonyl)imide is preferred in terms that an increase in thickness of the lithium alloy is prevented even when charging and discharging are repeated at a high current density.

Examples of the organic solvent are not particularly limited as long as being capable of dissolving the supporting electrolyte, and include ethylene carbonate, propylene carbonate, vinylene carbonate, fluoroethylene carbonate, dimethyl carbonate, diethyl carbonate, ethyl methyl carbonate, tetrahydrofuran, 2-methyltetrahydrofuran, tetrahydropyran, 1,3-dioxolane, 4-methyl-1,3-dioxolane, 1,2-dimethoxyethane, 1,2-diethoxyethane, ethoxymethoxyethane, diethyl ether, 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl)ether, 1,2-bis(1,1,2,2-tetrafluoroethoxy)ethane, anisole, sulfolane, methylsulfolane, γ-butyrolactone, acetate esters, butyrate esters, propionate esters, acetonitrile, and propionitrile, and two or more of these may be used in combination. Among these, 1,2-dimethoxyethane is preferred, and the combination of 1,2-dimethoxyethane and 1,1,2,2-tetrafluoroethyl-2,2,2-trifluoroethyl ether is more preferred in terms that decomposition is prevented even when charging and discharging are repeated at a high current density.

The negative electrode includes a lithium metal layer or a lithium alloy layer formed on a negative electrode current collector, for example. At this time, the lithium metal layer or the lithium alloy layer is disposed to face the functional layer of the separator, for example. As the lithium alloy, any known lithium alloy can be used capable of being applied to the lithium ion secondary battery. The thickness of the lithium metal layer or the lithium alloy layer is not particularly limited, and is 1 μm or more and 100 μm or less, for example.

Examples of materials constituting the negative electrode current collector are not particularly limited, and include silver, palladium, gold, platinum, aluminum, copper, nickel, stainless steel, and carbon. Among these, copper, stainless steel, and nickel are preferred in terms of conductivity and cost.

Examples of shapes of the negative electrode current collector are not particularly limited, and include a foil shape, a plate shape, a mesh shape, a nonwoven fabric shape, and a foaming shape.

The thickness of the negative electrode current collector is not particularly limited, and is 1 μm or more and 100 μm or less, for example.

The positive electrode includes a positive electrode mixture layer formed on the positive electrode current collector, for example.

The positive electrode mixture layer contains a positive electrode active material. Examples of the positive electrode active material are not particularly limited, and include lithium cobalt oxide (LiCoO₂), lithium nickel oxide (LiNiO₂), LiNiₚMn_{q}COᵣO₂ (p+q+r=1), LiNiₚAl_{q}CoᵣO₂ (p+q+r=1), lithium manganese oxide (LiMn₂O₄), Li₁₊ₓMn_{2-x-y}M_{y}O₄ (x+y=2) (wherein M is one or more elements selected from the group consisting of Al, Mg, Co, Fe, Ni, and Zn), lithium titanate, and LiMPO₄ (wherein M is one or more elements selected from the group consisting of Fe, Mn, Co, and Ni).

The content of the positive electrode active material in the positive electrode mixture layer is not particularly limited, and is 50% by mass or more and 99% by mass or less.

The positive electrode mixture layer may further contain a solid electrolyte. Examples of the solid electrolyte are not particularly limited as long as being capable of conducting lithium ions, and include oxide solid electrolytes and sulfide solid electrolytes.

The positive electrode mixture layer may further contain a binder, a conductive additive, and the like.

An example of a method of forming the positive electrode mixture layer is not particularly limited, and includes a method of applying slurry containing a positive electrode active material and a solvent.

Examples of materials constituting the positive electrode current collector are not particularly limited, and include aluminum, aluminum alloys, stainless steel, nickel, iron, and titanium. Among these, aluminum, aluminum alloys, and stainless steel are preferred.

Examples of shapes of the positive electrode current collector are not particularly limited, and include a foil shape and a plate shape.

Although the embodiment of the present invention has been described above, the present invention is not limited to the above-described embodiment, and the above-described embodiment may be modified as appropriate within the scope of the spirit of the present invention.

### EXAMPLES

Examples of the present invention will be described below, but the present invention is not limited to these Examples.

### [Preparation of Positive Electrode]

Using a planetary centrifugal mixer, 2 parts by mass of acetylene black (AB), 1.5 parts by mass of polyvinylidene fluoride (PVDF), polyvinylpyrrolidone (PVP), and N-methyl-2-pyrrolidone (NMP) were premixed to obtain a premixed slurry. Next, LiNi_{0.8}Co_{0.1}Mn_{0.1}O₂ (NCM811) and the premixed slurry were mixed using a planetary mixer to obtain a paste for a positive electrode mixture layer. Here, the NCM811 has a median diameter (D50) of 4 μm. Next, the paste for the positive electrode mixture layer was applied to an aluminum foil, dried, and then pressed with a rolling press to form a positive electrode mixture layer having a thickness of 65 μm and a density of 3.3 g/cm³. Next, the positive electrode mixture layer was dried in vacuo at 120° C. to obtain a positive electrode plate, and then the positive electrode plate was punched out to a size of 30 mm×40 mm to obtain a positive electrode.

### [Preparation of Negative Electrode]

A clad material of copper foil having a thickness 10 μm and lithium foil having a thickness of 20 μm was punched out to a size of 34 mm×44 mm to obtain a negative electrode including a lithium metal layer.

### Example 1

### (Separator)

A separator (commercially available product) was used, in which a functional layer having a thickness of 2 μm and containing alumina particles was formed on one side of a polyethylene microporous membrane with a porosity of 45%, an average pore diameter of 45 nm, and a thickness of 11 μm. The separator had an ionic resistance of 0.19 Ω·cm².

### (Electrolytic Solution)

An electrolytic solution (commercially available product) containing lithium bis(fluorosulfonyl)imide (LiFSI), 1,2-dimethoxyethane (DME), and 1,1,2,2-tetrafluoroethyl-2,2,2-trifluoroethyl ether (TTE) was used. The electrolytic solution had a concentration of LiFSI of 2.12 mol/L, a molar ratio of DME to TTE of 1.2, and a viscosity at 20° C. of 6.0 mPa·s.

### (Preparation of Lithium Ion Secondary Battery)

A positive electrode, a separator, and a negative electrode were introduced into a bag-shaped container made by heat-sealing an aluminum laminate for secondary batteries (manufactured by Dai Nippon Printing Co., Ltd.), and then 350 μL of an electrolytic solution was poured into the container, which was left at 25° C. for 5 hours. The functional layer of the separator was disposed to face a lithium metal layer of the negative electrode. Next, a constant current charge was carried out at 0.05 C to 4.1 V, and a constant current discharge was then carried out at 0.7 C to 2.65 V, which was left for 10 minutes. Next, a constant current/constant voltage charge was carried out at 0.05 C to 3.687 V, which was left at 45° C. for 24 hours and left at 25° C. for 24 hours, and then a constant current discharge was carried out at 0.7 C to 2.65 V, whereby a lithium ion secondary battery was obtained. At this time, a restraint load of the lithium ion secondary battery was set to 1.0 MPa.

### Example 2

### (Separator)

A separator (commercially available product) was used, in which a functional layer having a thickness of 2 μm and containing alumina particles was formed on one side of a polyethylene microporous membrane with a porosity of 45%, an average pore diameter of 45 nm, and a thickness of 12 μm. The separator had an ionic resistance of 0.25 Ω·cm².

### (Preparation of Lithium Ion Secondary Battery)

A lithium ion secondary battery was obtained in the same manner as in Example 1, except that the above-described separator was used.

### Example 3

### (Separator)

A separator (commercially available product) was used, in which a functional layer having a thickness of 4 μm and containing alumina particles was formed on one side of a polyethylene microporous membrane with a porosity of 45%, an average pore diameter of 45 nm, and a thickness of 12 μm. The separator had an ionic resistance of 0.29 Ω·cm².

### (Preparation of Lithium Ion Secondary Battery)

A lithium ion secondary battery was obtained in the same manner as in Example 1, except that the above-described separator was used.

### Example 4

### (Separator)

A separator (commercially available product) was used, in which a functional layer having a thickness of 2 μm and containing alumina particles was formed on one side of a polyethylene microporous membrane with a porosity of 41%, an average pore diameter of 44 nm, and a thickness of 9 μm. The separator had an ionic resistance of 0.14 Ω·cm².

### (Preparation of Lithium Ion Secondary Battery)

A lithium ion secondary battery was obtained in the same manner as in Example 1, except that the above-described separator was used.

### Example 5

### (Preparation of Lithium Ion Secondary Battery)

A lithium ion secondary battery was obtained in the same manner as in Example 1, except that the restraint load was changed to 0.8 MPa.

### Example 6

### (Preparation of Lithium Ion Secondary Battery)

A lithium ion secondary battery was obtained in the same manner as in Example 1, except that the restraint load was changed to 2.0 MPa.

### Comparative Example 1

### (Separator)

A separator (commercially available product) was used, in which a functional layer having a thickness of 2 μm and containing alumina particles was formed on one side of a polyethylene microporous membrane with a porosity of 448, an average pore diameter of 70 nm, and a thickness of 10 μm. The separator had an ionic resistance of 0.32 Ω·cm².

### (Preparation of Lithium Ion Secondary Battery)

A lithium ion secondary battery was obtained in the same manner as in Example 1, except that the above-described separator was used.

### Comparative Example 2

### (Separator)

As a separator, a polyethylene microporous membrane (commercially available product) with a porosity of 50%, an average pore diameter of 55 nm, and a thickness of 9 μm was used. The separator had an ionic resistance of 0.21 Ω·cm².

### (Preparation of Lithium Ion Secondary Battery)

A lithium ion secondary battery was obtained in the same manner as in Example 1, except that the above-described separator was used.

### Comparative Example 3

### (Separator)

As a separator, a polyethylene microporous membrane (commercially available product) with a porosity of 50%, an average pore diameter of 55 nm, and a thickness of 8 μm was used. The separator had an ionic resistance of 0.12 Ω·cm².

### (Preparation of Lithium Ion Secondary Battery)

A lithium ion secondary battery was obtained in the same manner as in Example 1, except that the above-described separator was used.

### Comparative Example 4

### (Electrolytic Solution)

An electrolytic solution (commercially available product) containing lithium bis(fluorosulfonyl)imide (LiFSI), 1,2-dimethoxyethane (DME), and 1,1,2,2-tetrafluoroethyl-2,2,2-trifluoroethyl ether (TTE) was used. The electrolytic solution had a concentration of LiFSI of 2.49 mol/L, a molar ratio of DME to TTE of 2.3, and a viscosity at 20° C. of 11.0 mPa·s.

### (Preparation of Lithium Ion Secondary Battery)

A lithium ion secondary battery was obtained in the same manner as in Example 1, except that the above-described electrolytic solution was used.

### Comparative Example 5

### (Preparation of Lithium Ion Secondary Battery)

A lithium ion secondary battery was obtained in the same manner as in Comparative Example 4, except that the restraint load was changed to 2.0 MPa.

### [Viscosity of Electrolytic Solution]

A viscosity of the electrolytic solution at 20° C. was measured using a digital viscometer DV2T (manufactured by BROOKFIELD).

[Ionic Resistance per Unit Area of Separator Saturated and Impregnated with Electrolytic Solution]

The separator was punched out to a size of 19 mm in diameter to obtain a separator for ionic resistance measurement. Next, a separator for ionic resistance measurement was placed on a spacer made of SUS, and then 150 μL of an electrolytic solution was dropped onto the separator for ionic resistance measurement to saturate and impregnate the separator. Next, a spacer made of SUS was placed on the separator for ionic resistance measurement which was saturated and impregnated with the electrolytic solution, to obtain a cell for ionic resistance measurement. The cell for ionic resistance measurement was prepared by stacking two and three stacked separators for ionic resistance measurement which was saturated and impregnated with the electrolytic solution.

Using an AC impedance method, an AC current of 1×10⁶ to 0.1 Hz was applied to the cell for ionic resistance measurement, and an ionic resistance [Ω] was calculated from the intersection with the real axis of the Nyquist plot obtained. The slope of the plot of ionic resistance against the number of separators for ionic resistance measurement (ionic resistance per separator for ionic resistance measurement) was divided by an area of the separator for ionic resistance measurement to calculate the ionic resistance per unit area [Ω·cm²].

### [Resistance Per Unit Area of Positive Electrode]

A resistance per unit area of the positive electrode of the lithium ion secondary battery was measured. Specifically, a constant current charge was carried out at 25° C. and 4.5 C up to 50% of an initial discharge capacity in the lithium ion secondary battery to hold SOC of 50%, and then a discharge was carried out at 4.5 C for 10 seconds, whereby the resistance was calculated. Next, the resistance was divided by the area (12 cm²) of the positive electrode to calculate the resistance per unit area [Ω·cm²] of the positive electrode.

### [Capacity Retention Rate]

A capacity retention rate of the lithium ion secondary battery was evaluated. Specifically, first, a constant current/constant voltage charge was carried out at 25° C. and ⅓ C to 4.25 V, and then a constant voltage charge was carried out for 20 minutes, which was left for 10 minutes. Next, a constant current discharge was carried out at 25° C. and ⅓ C to 3.0 V to measure an initial discharge capacity.

In the same manner as above, charging and discharging (4.25 V to 3.0 V) was carried out 48 times, which was left for 6 hours. Next, charging and discharging (4.25 V to 3.0 V) was carried out in the same manner as above to measure a discharge capacity. Next, the capacity retention rate was calculated using the following formula.

$$( discharge capacity ) / ( initial discharge capacity ) \times 100$$

### [Thickness of Lithium Metal Layer]

A constant current charge was carried out for the lithium ion secondary battery, for which the capacity retention rate was evaluated, at 25° C. and ⅓ C to 4.25 V (SOC of 100%), and then the lithium ion secondary battery was disassembled to remove the negative electrode. Next, the thickness of the lithium metal layer was measured using a contact type film thickness meter.

### [Incidence Rate of Micro Short-Circuit]

A constant current/constant voltage charge was carried out for the lithium ion secondary battery, of which the initial discharge capacity was measured, at 25° C. and 0.1 C to 0.05 C and 3.629 V to hold SOC of 208, and then the following operation was carried out to evaluate the presence or absence of an incidence of a micro short-circuit.

(1) A constant current charge was carried out at 25° C. and 1.68 C to 3.823 V.

(2) A constant current charge was carried out at 25° C. and 1.30 C to 4.052 V.

(3) A constant current charge was carried out at 25° C. and 1.18 C to 4.173 V.

(4) It was left at 25° C. for 10 minutes.

(5) A constant current/constant voltage discharge was carried out at 25° C. and 0.40 C to 0.05 C and 3.629 V.

(6) The operations (1) to (5) were carried out 48 times.

(7) The operations (1) to (5) were carried out to measure a discharge capacity.

(8) The operations (1) to (7) were carried out 100 times.

The criteria for determining the micro short-circuit are as follows. Absence of micro short-circuit: when the voltage of the lithium ion secondary battery is 2.4 V or higher during charging and discharging from the start of the prototype. Presence of micro short-circuit: when the voltage of the lithium ion secondary battery is lower than 2.4 V during charging and discharging from the start of the prototype.

The lithium ion secondary battery was evaluated for the presence or absence of the incidence of the micro short-circuit, with N=5, and the incidence rate of the micro short-circuit was calculated.

### [Rate of Change in Thickness of Separator]

The separator was punched out to a size of 5 cm×5 cm to obtain a separator for evaluation. Next, 30 separators for evaluation were stacked and clamped in a jig, and then compressed using a uniaxial hydraulic hand press at a pressure of 3 MPa for 100 hours, and the thickness of the separators for evaluation after compression was measured. The thicknesses of the separator for evaluation were measured at five points of four corners and a center, using a contact type film thickness meter, and an average value of the thicknesses was taken as a thickness of the separator for evaluation. Next, the rate of change in thickness of the separator was calculated using the following formula.

$$[ ( thickness of separator for evaluation before compression ) - ( thickness of separator for evaluation after compression ) ] / ( thickness of separator for evaluation before compression ) \times 100$$

Table 1 shows evaluation results of the lithium ion secondary battery.

TABLE 1

| | | | | | | Resistance | | Thick- | Incidence |
|---|---|---|---|---|---|---|---|---|---|
| | | Separator | | | | per unit | | ness | rate of |
| | Electrolytic | | Functional | Rate of | | area of | Capacity | of Li | micro |
| | solution | Ionic | layer/Substrate | change in | Restraint | positive | retention | metal | short- |
| | Viscosity | resistance | (Ratio of | thickness | load | electrode | rate | layer | circuit |
| | [mPa · s] | [Ω/cm²] | thickness) | [%] | [MPa] | [Q · cm²] | [%] | [μm] | [%] |
| Example1 | 6.0 | 0.19 | 0.18 | 8.3 | 1.0 | 18.5 | 98 | 64 | 20 |
| Example2 | 6.0 | 0.25 | 0.17 | 8.3 | 1.0 | 18.5 | 98 | 68 | 0 |
| Example3 | 6.0 | 0.29 | 0.29 | 8.3 | 1.0 | 18.0 | 98 | 85 | 2 |
| Example4 | 6.0 | 0.14 | 0.22 | 10.0 | 1.0 | 16.0 | 98 | 62 | 20 |
| Example5 | 6.0 | 0.19 | 0.18 | 8.3 | 0.8 | 18.5 | 98 | 66 | 20 |
| Example6 | 6.0 | 0.19 | 0.18 | 8.3 | 2.0 | 18.5 | 98 | 64 | 20 |
| Comparative | 6.0 | 0.32 | 0.20 | 5.0 | 1.0 | 20.0 | 96 | 92 | 100 |
| Example1 | | | | | | | | | |
| Comparative | 6.0 | 0.21 | 0 | 11.1 | 1.0 | 16.0 | 96 | 73 | 60 |
| Example2 | | | | | | | | | |
| Comparative | 6.0 | 0.12 | 0 | 37.5 | 1.0 | 16.0 | 96 | 68 | 60 |
| Example3 | | | | | | | | | |
| Comparative | 11.0 | 0.21 | 0.18 | 8.3 | 1.0 | 20.0 | 96 | 85 | 40 |
| Example4 | | | | | | | | | |
| Comparative | 11.0 | 0.21 | 0.18 | 8.3 | 2.0 | 20.0 | 94 | 92 | 40 |
| Example5 | | | | | | | | | |

It can be seen from Table 1 that the lithium ion secondary batteries of Examples 1 to 6 have a low incidence rate of the micro short-circuit even when charging and discharging are repeated at a high current density. This is because the lithium metal is uniformly dissolved and precipitated at the negative electrode during charging and discharging. In contrast, in the lithium ion secondary battery of the Comparative Example 1, the ionic resistance per unit area of the separator saturated and impregnated with the electrolytic solution is 0.32 Ω·cm², and therefore, the incidence rate of the micro short-circuit increases when charging and discharging are repeated at a high current density. This is because the lithium metal is unevenly dissolved and precipitated at the negative electrode during charging and discharging, resulting in forming dendrites easily. In the lithium ion secondary batteries of Comparative Examples 2 and 3, since no functional layer is formed on the separator, the incidence rate of the micro short-circuit increases when charging and discharging are repeated at a high current density. In the lithium ion secondary batteries of Comparative Examples 4 and 5, since the viscosity at 20° C. is 11 mPa·s, the incidence rate of the micro short-circuit increases when charging and discharging are repeated at a high current density. This is because the lithium metal is unevenly dissolved and precipitated at the negative electrode during charging and discharging, resulting in forming dendrites easily.

Here, the lithium ion secondary batteries of Comparative Examples 1 and 5 have a higher resistance per unit area of the positive electrode and a thicker Li metal layer than the lithium ion secondary batteries of Examples 1 and 6, which have the same configuration except for the separator. Furthermore, the lithium ion secondary battery of Comparative Example 4 has a higher resistance per unit area of the positive electrode and a thicker Li metal layer than the lithium ion secondary battery of Example 1, which has the same configuration except for the electrolytic solution.

What is claimed is:

1. A lithium ion secondary battery comprising:
a positive electrode; a negative electrode containing a lithium metal or a lithium alloy; an electrolytic solution; and a separator,
wherein the electrolytic solution has a viscosity at 20° C. of less than 7.0 mPa·s,
the separator includes a substrate and a functional layer formed on at least one surface of the substrate, and
the separator saturated and impregnated with the electrolytic solution has an ionic resistance per unit area of 0.30 Ω·cm² or less.

2. The lithium ion secondary battery according to claim 1, wherein the separator saturated and impregnated with the electrolytic solution has an ionic resistance per unit area of 0.25 Ω·cm² or less.

3. The lithium ion secondary battery according to claim 1, wherein the functional layer contains inorganic oxide particles.

4. The lithium ion secondary battery according to claim 1, wherein, in the separator, a ratio of a thickness of the functional layer to a thickness of the substrate is 0.30 or less.

5. The lithium ion secondary battery according to claim 4, wherein, in the separator, the ratio of the thickness of the functional layer to the thickness of the substrate is 0.25 or less.

6. The lithium ion secondary battery according to claim 1, wherein a rate of change in thickness of the separator after application of a pressure of 3 MPa for 100 hours is 11.0% or less.

7. The lithium ion secondary battery according to claim 1, wherein the lithium ion secondary battery has an initial restraint load of 0.5 MPa or more.
